(19) United States
(12) Patent Application Publication
(10) Pub. No.: US 2019/0177224 A1
(43) Pub. Date: Jun. 13, 2019

(54) PHASE-CHANGE MATERIAL FOR STORING THERMAL ENERGY, MANUFACTURING METHOD AND USES OF SUCH A MATERIAL

(71) Applicant: UNIVERSITE CERGY-PONTOISE, Cergy (FR)

(72) Inventors: Thibault HARLE, Andresy (FR); Béatrice LEDESERT, Cormeilles En Vexin (FR); Tran Minh Giao NGUYEN, Courbevoie (FR); Ronan HEBERT, Magny-En-Vexin (FR); Yannick MELINGE, Montmorency (FR)

(73) Assignee: UNIVERSITE CERGY-PONTOISE, Cergy (FR)

(21) Appl. No.: 16/302,440

(22) PCT Filed: May 12, 2017
(86) PCT No.: PCT/FR2017/051153

§ 371 Date: Nov. 16, 2018

(30) Foreign Application Priority Data
May 18, 2016 (FR) 1654431

(51) Int. Cl. C04B 24/28; C08G 18/48; C08G 18/32; C08G 18/66; C08G 18/73; C09K 5/14; C04B 28/02

(52) U.S. Cl. CPC C04B 24/282; C08G 18/4833; C08G 18/3206; C04B 2103/0071; C08G 18/73; C09K 5/14; C04B 28/02; C08G 18/6677

(57) ABSTRACT

A method for synthesizing a solid-solid organic phase-change material made of polyurethane, said method comprising:
a step (i) of mixing and reacting a liquid polyethylene glycol, a crosslinking agent and a liquid polyisocyanate, by mechanical agitation, at a first controlled temperature, in an enclosure in order to obtain the liquid polyurethane,
a step (ii) of curing the liquid polyurethane at a second controlled temperature in order to solidify the polyurethane,
the mixing of step (i) being carried out in the absence of solvent.

The invention relates to the technical field of thermal energy storage by a phase-change material.

Phase-change materials (henceforth PCMs) can be classified according to their chemical nature: Organic PCMs (for example paraffins, fatty acids, polyalcohols), inorganic PCMs (for example salt hydrates, mineral salts, metals such as potassium or lithium), eutectic PCMs.

PCMs can be classified by the type of phase change that they undergo during a temperature change: gas-liquid PCM, solid-liquid PCM, solid-gas PCM, solid-solid PCM.

The invention relates more specifically to the technical field of thermal energy storage by a solid-solid organic PCM.

The invention has applications in the construction field in particular. The use of PCMs in buildings makes it possible to dampen and smooth out thermal fluctuations inside rooms and to maintain a pleasant, comfortable mean temperature.

The use of PCMs in buildings also makes it possible to limit the increase in temperature during full sun exposure and to supply heat during a less warm period of the day, thus cutting back on the use of air conditioning.

The use of PCMs in buildings is of significant interest in renovation and in structures comprising extensive glass surfaces and walls of reduced thickness, such as those of low thermal mass buildings with wood construction.

For an overview of the state of the art concerning the uses of PCMs in buildings, reference can be made, for example, to the following documents: Kosny, PCM-Enhanced building components, an application of phase change materials in building envelopes and internal structures 2015, ISSN 1619-0181; Sharma et al, Developments in organic solid-liquid phase storage change materials and their applications in thermal energy storage, Energy Conversion and Management, 2015, pp. 193-228; Drissi, Développement de nouveaux bétons accumulateurs d'énergie, Thesis, Université Paris Est, 2015; Guichard, Contribution à l'étude des parois complexes integrant des matériaux à changement de phase, Thesis, Université de la Réunion, 2013; Lopez, Mëthodologie de conception des matériaux architecturés pour le stockage latent dans le domaine du bâtiment, Thesis, insa Lyon, 2013.

The invention also has applications in the automotive, pharmaceutical, medical, electronics, energy heating systems (radiators, heating panels, heat accumulators, etc.) industries.

The PCMs most often used in the construction industry are solid-liquid types, made of paraffin or metallic salts. Paraffin waxes (e.g., tetradecane, hexadecane, octadecane, eicosane) have thermal conductivities of around 0.15 W/mK and enthalpies of fusion ranging from 140 to 250 kJ/kg.

Methods of impregnating liquid PCMs (paraffin, salts), specifically in plaster, are known. Impregnating plaster with liquid PCM has several disadvantages. In particular, this impregnation induces a color change and risks of seepage.

PCMs made of paraffin have numerous disadvantages. In particular, PCMs made of paraffin have low thermal conductivities, are flammable, and their volume varies with their change of state.

In attempts to remedy these disadvantages, PCMs made of paraffin are encapsulated, particularly for incorporation into construction materials such as plaster or concrete.

According to a first known technique, solid-liquid PCMs are macro-encapsulated, in other words packaged in containers with volumes varying from a milliliter to several liters, depending on the intended uses. For example, these containers are polymer bags, plates or sheets or rust-proof metal balls.

According to a second known technique, the solid-liquid PCMs are micro-encapsulated, the size of the microcapsules typically varying from one micron to one millimeter. The microcapsules are usually made of a polymer of natural, hemisynthetic or synthetic origin. Micro-encapsulation is achieved by, for example, interfacial polymerization or spray drying. The spray-drying method involves the formation of a solution, suspension or emulsion containing a polymer and the PCM, an aerosol being formed by spraying by a pneumatic, ultrasonic or rotary nozzle. During this spraying, solid microcapsules form after evaporation in a drying chamber, with the aid of an air or nitrogen flow. For a general overview of micro-encapsulation techniques, reference can be made, for example, to the document Rosa et al, http://dx.doi.org/10.5772/50206, or to the document Su et al, Review of solid-liquid phase change materials and their encapsulation technologies, Renewable and Sustainable Energy Reviews 2015, pp. 373-391.

Micro-encapsulated PCMs are widely available commercially in materials for the construction of buildings or for renovation.

Under the brand name Energain®, DuPont offers plates consisting of an ethylene polymer/paraffin-based PCM mixture enveloped by two thin coatings of aluminum. These panels can be cut to size and then attached to walls by gluing, stapling or bolting.

Under the brand name Micronal®, BASF offers a paraffin wax that is micro-encapsulated by polymethyl methacrylate (PMMA). For example, reference can be made to documents U.S. Pat. No. 7,166,355 (BASF, 2007), US 2012/0196116 (BASF, 2012). Several commercial products comprise a Micronal® micro-encapsulated PCM from BASF in a gypsum matrix: Comfortboard from Knauf, Thermlacore® from National Gypsum, Alba Balance® from Saint Gobain.

Several manufacturers sell plaster comprising micro-encapsulated PCMs. Weber (Saint Gobain group) offers a thermal mass plaster under the brand name Weber.Mur®. Maxit Deutschland GmbH (Saint Gobain group) offers a single-layer plaster coating for interior use under the brand name Maxit-Clima. Winco Technologies (Winco group) offers an interior coating under the brand name Enerciel.

Also known are diverse composite products comprising micro-encapsulated PCMs (such as the ones offered by Rubitherm GmbH). Suspended ceiling panels comprising micro-encapsulated PCMs are offered by Datum Phase Change Ltd under the brand name Thermacool®. Under the brand name Coolzone®, Armstrong offers suspended ceiling panels comprising micro-encapsulated PCMs.

Although widespread commercially, PCM encapsulation has numerous disadvantages.

During manufacturing, in particular by spray drying, a portion of the PCM is lost by adhesion to the sides of the production apparatus.

Moreover, during the micro-encapsulation, it is necessary to apply a barrier layer (of PMMA, for example) to minimize the risks of PCM leakage. Furthermore, the encapsulation process consumes a considerable amount of energy, both for producing the PCM and for encapsulating it.

The incorporation of micro-encapsulated PCMs into construction materials poses numerous problems.

The microcapsules have a tendency to agglomerate and form clumps, and they may be damaged while being mixed with an adhesive material by the shearing effect during the mixing process, leading to a leakage of the PCM, particularly a leakage of paraffin, which can affect the thermal and mechanical properties of the adhesive material containing the micro-encapsulated PCM.

PCM seepage at the surface of a construction element, brought about by a rupturing of the microcapsules, can have detrimental effects on the indoor air quality and on the fire resistance of the construction element. The development of the first plaster-paraffin panel in France in the 1970s was limited as a consequence of these flammability and paraffin seepage risks. Moreover, seepage has a negative impact on the appearance of the construction element.

Products comprising micro-encapsulated PCMs cannot be subjected to mechanical actions (specifically cutting, sanding, drilling) without risk of damaging the microcapsules and releasing the PCM.

In an effort to remedy these problems, in rare cases, it has been proposed to use solid-solid PCMs without micro-encapsulation in lieu of micro-encapsulated solid-liquid PCMs. Document FR2575757 proposes mixing an organic polyol solid-solid PCM by incorporation into a plaster matrix for use on buildings.

The invention relates more specifically to the technical field of thermal energy storage by means of a solid-solid organic PCM made of polyurethane.

The use of polyurethane resins as solid-solid PCMs has been rarely proposed in the prior art; see for example French patent FR 2309620 (Ciba-Geigy, 1976, page 3 lines 14-28).

The use of polyurethanes as PCMs in fact poses numerous problems, the resolution of which is an object of the invention.

A first problem is that polyurethanes are conventionally synthesized from isocyanates in the presence of solvents, with the effects in terms of hygiene and work safety resulting therefrom. By way of example, reference can be made to documents CN 101891877, CN 101781394, CN 1958711. It is thus standard practice to synthesize polyurethanes from polyisocyanates and polyols using
N,N Dimethylformamide DMF (see for example Alkan et al, Polyurethane as solid-solid phase change materials for thermal energy storage Solar Energy 86 (2012) pp. 1761-1769; Su et al, A novel solid-solid phase change heat storage material with polyurethane block copolymer structure, Energy Conversion and Management 47 (2006), pp. 3185-3191; Cao et al, Hyperbranched polyurethane as novel solid-solid phase change material for thermal energy storage, European Polymer Journal 42 (2006), pp. 2931-2939; Chen et al, Linear polyurethane ionomers as solid-solid phase change materials for thermal energy storage, Solar Energy Materials and solar cells, 130 (2014), pp. 466-476; Xi et al, Synthesis and thermal energy storage properties of the polyurethane solid-solid phase change materials with a novel tetrahydroxy compound, European Polymer Journal, 48 (2012), pp. 1295-1303, Peng et al, Solar Energy Materials & Solar Cells, 145 (2016), pp. 238-247, Li et al, Preparation and characterization of cross-linking PEG/MDI/PE copolymer as solid-solid phase change heat storage material, Solar Energy Materials & Solar Cells 91 (2017), pp. 764-768), the MSDS of N,N Dimethylformamide indicating a possibility of acute and chronic toxicity to human beings;
or THF tetrahydrofuran CAS 109-99-9, (see for example Xi et al, Preparation and performance of a novel thermoplastics polyurethane solid-solid phase change materials for energy storage, Solar Energy Materials and solar cells, 102 (2012), pp. 36-43), the MSDS of THF indicating a possibility of acute and chronic toxicity to human beings.

A second problem is that aromatic polyisocyanates (e.g., diphenylmethane diisocyanate, MDI), products that are eye and upper respiratory tract irritants with the risks that may result from them in the event of incomplete reaction, are conventionally used in the synthesis of polyurethanes.

A third problem is that polyurethanes are conventionally synthesized from polyisocyanates in the presence of catalysts, specifically organometallic, amine, guanidine, carbene catalysts (see for example Fu et al, Thermosetting solid-solid phase change materials composed of polyethylene glycol based two components: flexible application for thermal energy storage, Chemical Engineering Journal 291 (2016), pp. 138-148). Organometallic catalysts, in particular ones containing mercury, are known to be toxic.

A fourth problem is that during the synthesis of polyurethanes, the reaction of isocyanates with water produces a highly unstable carbamic acid, the decomposition of this acid leading to an amine and to a release of carbon dioxide:

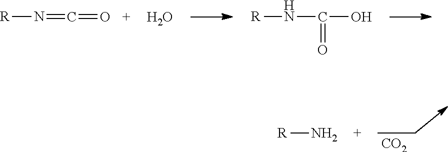

The amine thus produced in turn reacts with the isocyanate functional groups, resulting in the formation of urea groups:

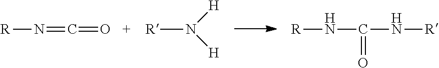

A rehydration during synthesis can thus lead to the formation of bubbles, which remain trapped in the PU. Moreover, an incomplete isocyanate reaction leads to a risk of urea being produced when the PCM comes into contact with humid ambient air. Urea has an unpleasant ammonia-like odor.

A first object is to propose a solid-solid organic phase-change material made of polyurethane that can be synthesized without a solvent.

A second object is to propose a solid-solid organic phase-change material made of polyurethane that can be synthesized without a catalyst.

A third object is to propose a mixture comprising such a solid-solid organic phase-change material made of polyurethane and a construction material such as cement, lime, coating or plaster, said mixture capable of being employed without any risks and without any effects on indoor air quality.

A fourth object is to propose uses of such a solid-solid organic phase-change material made of polyurethane, specifically in the construction, automotive, pharmaceutical, medical, electronics, energy heating systems (radiators, heating panels, heat accumulators, etc.) industries.

To these ends, according to a first aspect, a method for manufacturing a solid-solid organic phase-change material made of polyurethane is proposed, said method comprising:
a single step (i) of synthesis by mixing and reacting a liquid polyethylene glycol, a crosslinking agent, and a liquid polyisocyanate, combined by mechanical agitation at a first controlled temperature, in an enclosure in order to obtain the liquid polyurethane,
a step (ii) of curing the liquid polyurethane at a second controlled temperature in order to solidify the polyurethane,
   the synthesis step (i) being carried out in the absence of a solvent.

The liquid polyethylene glycol serves as both a reagent and a solvent.

The synthesis step (i) is advantageously carried out without a catalyst.

In the synthesis step (i), the polyethylene glycol is advantageously mixed with the crosslinking agent to prepare these reagents, and then the polyethylene glycol-crosslinking agent composition is mixed with the polyisocyanate, the polyethylene glycol and the crosslinking agent reacting with the NCO bonds of the polyisocyanate.

According to diverse implementations, the method has the following features, combined where applicable:
the polyisocyanate is chosen from the group comprising MDI (diphenylmethane diisocyanate CAS 9016-87-9), IPDI (isophorone diisocyanate CAS 4098-71-9), HMDI (hexamethylene diisocyanate CAS 822-06-0), NDI (naphthalene diisocyanate CAS 3173-72-6), LDI (lysine diisocyanate CAS 45172-15-4), XDI (xylene diisocyanate CAS 3634-81-3). The polyisocyanate is advantageously aliphatic and less toxic than an aromatic polyisocyanate. In a special implementation, the polyisocyanate is HMDI;
the molar masses of the polyethylene glycol range from 200 g/mol to 2,000,000 g/mol, and more particularly from 1,000 g/mol to 10,000 g/mol, and still more particularly from 1,000 g/mol to 2,000 g/mol;
the NCO/OH ratio ranges from 1 to 1.5, and more particularly from 1 to 1.1;
the crosslinking rate ranges from 10% to 50%, and more particularly from 20% to 40%;
the enclosure is placed in an inert atmosphere, for example under a vacuum or under argon or nitrogen;
the method comprises a step of adding glycerol as a crosslinking agent;
the second controlled temperature ranges from 100° C. to 150° C., the curing step lasting several hours;
the first temperature is maintained at 70° C.;
after the air curing step (ii), the method comprises a comminution step.

In certain implementations, silica or carbon black fume is added to the reaction mixture during the synthesis step (i).

According to a second aspect, a solid-solid organic phase-change material made of polyurethane is proposed, which is formed from a polyethylene glycol, a crosslinking agent and a polyisocyanate and does not comprise any solvent residues.

According to a third aspect, a solid-solid organic phase-change material made of polyurethane is proposed, which is formed from a polyethylene glycol, a crosslinking agent and a polyisocyanate and does not comprise any solvent residues, and which can be obtained by a method such as described above.

The material advantageously does not comprise any catalyst residue.

The polyisocyanate is advantageously HMDI. In other implementations, the polyisocyanate is 1,8-diisocyanatooctane, CAS No. 10124-86-4. In other implementations, the polyisocyanate is a linear diisocyanate or a mixture of linear diisocyanates.

The material can be in the form of a solid powder or suspension.

The material is advantageously in the form of a powder in which the grain size ranges from 10 microns to 500 microns, and more particularly from 100 microns to 300 microns.

According to another aspect, a composite material is proposed, which comprises a hydraulic binder and a solid-solid organic phase-change material as described above.

The hydraulic binder is advantageously plaster.

In one implementation, the composite material comprises between 20% and 35% by mass of solid-solid organic phase-change material as described above.

According to another aspect, the use of a material as described above in a construction element for a building comprising a hydraulic binder, which gives rise to a composite material, is proposed.

According to diverse implementations, the phase-change material is dispersed, without encapsulation, in the binder and/or covers, at least partially, the surface of the construction element.

In other implementations, the phase-change material is in the form of a sheet or plate within a multi-layer construction element.

The PCM can be molded for forming all types of elements.

Other objects and advantages of the invention will be seen from the description of embodiments given below, with reference to the appended drawings, in which:

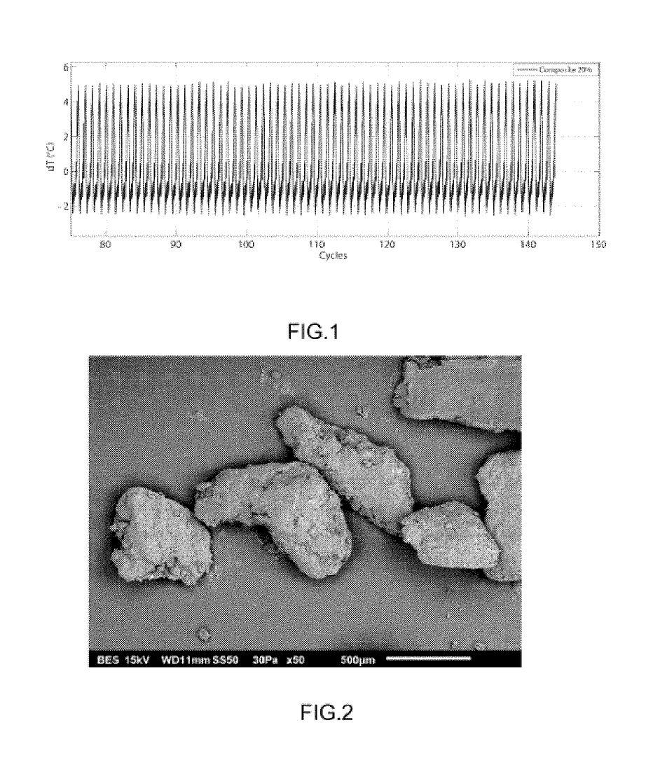

FIG. 1 is a diagram showing the variations in temperature of a plaster/PCM composite according to one embodiment;

FIG. 2 is a scanning electron microscopy image of a synthesized powdered PCM according to one embodiment;

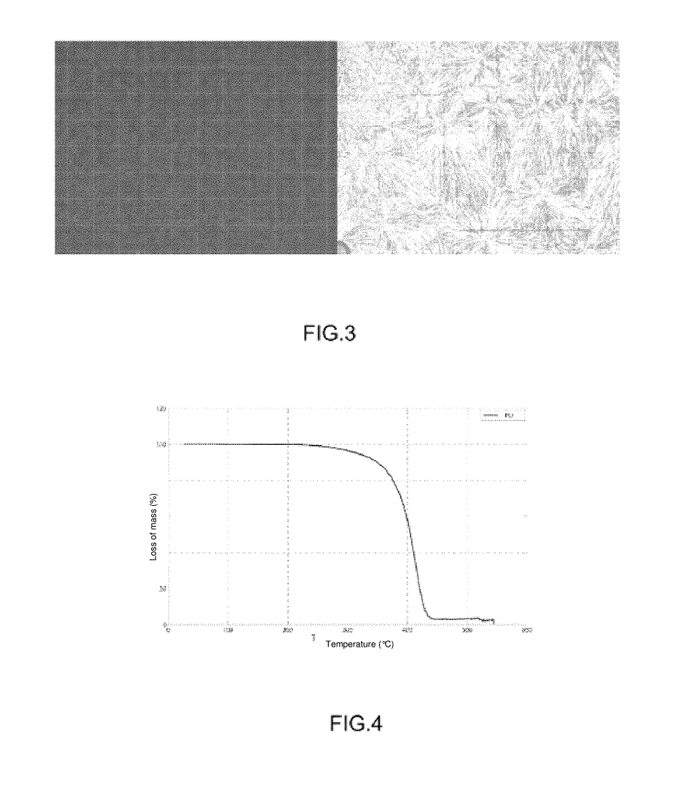

FIG. 3 is a view of a synthesized PCM analyzed in thin section and polarized light, the PCM having been brought to 80° C. (left side of FIG. 3) and to ambient temperature (right side of FIG. 3), the colors having been transformed into shades of gray for reproduction purposes;

FIG. 4 is a curve representing the percent loss of mass as a function of the temperature in degrees Celsius for a polyurethane with 30% crosslinking agent;

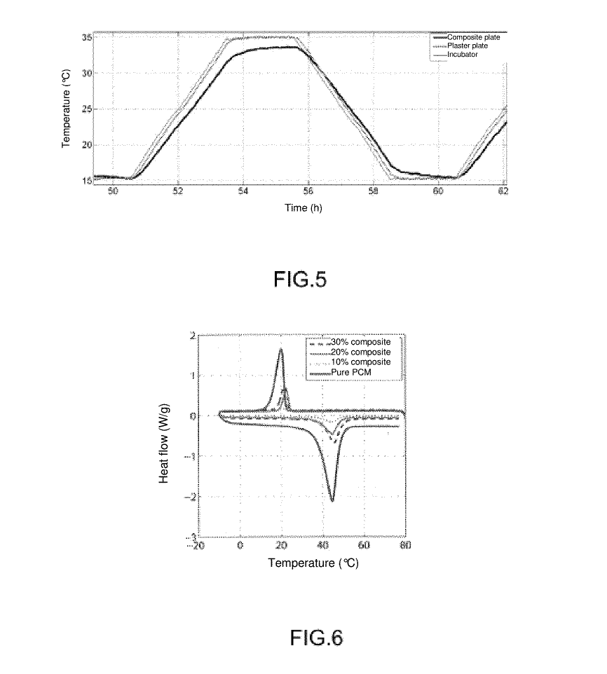

FIG. 5 is a view showing the temperature progression as a function of time for a control polyurethane plate made of plaster and for a plate with the same dimensions made of plaster-polyurethane composite, these plates being placed in a climatic chamber (incubator);

FIG. 6 is a view showing the DSC measurements taken on the plaster matrix composite materials comprising the PCMs.

The synthesis of thermosetting polyurethanes from a polyethylene glycol with a crosslinking agent such as HMDI or glycerol shall be described first.

As will be seen more completely in this description, this synthesis is advantageously performed without solvents, and still more advantageously without solvents and without catalysts.

Glycerol (CAS 56-81-5) is used as a crosslinking agent in a first type of synthesis. Possessing three hydroxyl functional groups, glycerol makes it possible to bond three chains by reacting with the HMDI.

In a second type of synthesis, HMDI plays its role as an isocyanate for the formation of polyurethanes and a role as a crosslinking agent by reacting with water to form amine functional groups, which then react with the isocyanate functional groups of the dry HMDI.

Hexamethylene diisocyanate (HMDI) is also called HDI, 1,6-hexamethylene diisocyanate, 1,6-diisocyanatohexane. C₈H₁₂N₂O₂/OCN—(CH₂)₆—NCO (CAS 822-06-0)

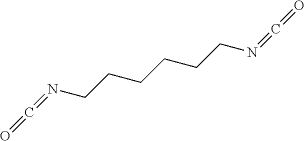 [SMILES: O=C=NCCCCCCN=C=O]

Polyethylene glycols (PEG) are linear polyethers with a molar mass less than 20,000 g/mol. When their molar mass is greater than 20,000 g/mol, they are called poly(ethylene oxide) or poly(oxyethylene) POE (CAS 25322-68-3). They occur as solids at ambient temperature at molar masses greater than 1.000.

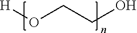

Three PEGs with molar masses of 1,000 g/mol, 1,500 g/mol and 2,000 g/mol, four NCO/OH ratios (0.8, 1, 1.05 and 1.1) and three crosslinking rates (20%, 30% and 40%) shall be considered in the following examples of implementation.

Where applicable, increasing the NCO/OH ratio makes it possible to compensate for the loss of a portion of the initial isocyanate functional groups due to reaction with moisture.

The size of the crystals observed in the polyurethane is influenced by the value of the NCO/OH ratio, the size of the crystals decreasing as the NCO/OH ratio increases.

The size of the crystals observed in the polyurethane is influenced by the molar mass of the PEG. For example, a size of 10 microns is observed for a PEG with a molar mass of 1,000 g/mol, a size of 20 microns is observed for a PEG with a molar mass of 1,500 g/mol, and a size of 100 microns is observed for a PEG with a molar mass of 2,000 g/mol.

The molar mass of the PEG does not significantly affect the degradation temperature of the polyurethanes obtained, which remain stable up to around 290° C.

The latent heat and transition temperatures of the polyurethanes obtained increase when the molar mass of the chosen PEG increases, as will be seen further below in this description.

The crosslinking rate percentages are calculated on the basis of the quantity of —OH functional groups contributed by the PEG, thus for n OH functional groups of the PEG, 0.2n or 0.4n OH functional groups will be added via the crosslinking agent. In other words, the crosslinking rate is the quantity of hydroxyl functional groups contributed by the glycerol in relation to the total quantity of hydroxyl functional groups: [OH] glycerol/total [OH].

The syntheses are carried out under argon in order to prevent the HMDI from coming into contact with the water present in the ambient air.

Nitrogen or another neutral gas can be used in lieu of argon. In other implementations, the reaction takes place in an enclosure under a vacuum.

The syntheses are advantageously carried out under neutral gas pressure, in particular a pressure of 1 bar, the neutral gas being nitrogen or argon. The implementation of a synthesis under neutral gas pressure leads to a nearly complete synthesis reaction, as well as to an increase in the latent heats of the PCMs obtained.

The PEG is poured into, for example, a round-bottomed cylindrical glass reactor, enabling a production of 100 to 500 g of PU.

The reactor is heated, for example, using a temperature-controlled oil bath. The temperature is maintained at 70° C.

The HMDI is added to the reactor in a single operation, for example with a syringe. The reaction time is short, for example 45 minutes.

Agitation is ensured by means of a mechanical stirrer, for instance one with a three-blade propeller (overhead stirrers, specifically the kind marketed by IKA).

The polymerization kinetics can be monitored, in a manner known per se, by infrared spectroscopy, by transmission or reflection, wherein this technique can be used directly in situ on a processing apparatus. For a description of these monitoring techniques, reference can be made to the document Viale, Etude chemiorhéologique de systèmes thermodurcissables dédiés à la comprehension du procédé de rotomoulage réactif, Thesis, INSA Lyon, 2009.

In one implementation, the reaction kinetics are monitored by the decrease in the isocyanate peak using a Fourier-transform infrared spectrometer (FTIR). The formation of urethane functional groups can be confirmed by the presence of a peak corresponding to the carbonyl functional groups or of a peak corresponding to the N—H functional groups.

Since the viscosity of the polyurethane increases as the reaction progresses, tests are performed in order to have a polyurethane that is still liquid enough to be removed from the enclosure.

In one implementation, the polyurethane obtained is poured into silicone molds and cured at a temperature of around 100° C. for a period of about four hours.

After this air curing, the polyurethanes are characterized by differential scanning calorimetry (DSC), thus enabling the transition temperatures and the latent heats of phase change to be determined. A thermogravimetric analysis is performed to determine the degradation temperature of the PCM, the degradation products being analyzed by infrared.

The polyurethanes obtained exhibit micro-separation between soft blocks and rigid blocks, with reversible order/disorder transitions.

The following table gives examples of synthesized polyurethanes, the isocyanate being HMDI, the crosslinking agent being glycerol, the % crosslinking agent column indicating the percentage of glycerol used. As can be seen for the [NCO]=NCO/OH ratio range considered, the transition temperatures diminish slightly and the latent heat diminishes as the [NCO] ratio increases.

| | | Cross- | | T crystal- | |
|---|---|---|---|---|---|
| | | linking | T fusion | lization | Latent |
| PEG | [NCO] | rate | ° C. | ° C. | heat J/g |
| 1000 | 1 | 0 | 18 | 25 | 89 |
| 1000 | 1 | 30 | 21 | 23 | 91 |
| 1000 | 1.05 | 0 | 12 | 21 | 72 |
| 1000 | 1.1 | 0 | 14 | 20 | 75 |
| 1500 | 1 | 0 | 31 | 27 | 83 |
| 1500 | 1.05 | 0 | 25 | 21 | 75 |
| 1500 | 1.1 | 0 | 24 | 20 | 75 |
| 1500 | 0.8 | 30 | 33 | 27 | 100 |
| 1500 | 1 | 20 | 27 | 23 | 90/105* P_{Ar} > 1 bar |
| 1500 | 1 | 30 | 26 | 31 | 82 |
| 1500 | 1 | 40 | 30 | 27 | 90 |
| 1500 | 1.05 | 30 | 22 | 22 | 80 |
| 1500 | 1.1 | 30 | 22 | 21 | 77 |
| 2000 | 1 | 0 | 49 | 29 | 105 |
| 2000 | 1 | 20 | 32 | 25 | 94 |
| 2000 | 1 | 30 | 30 | 30 | 95 |

The thermogravimetric analyses were performed on 10-mg samples heated at the rate of 20° C./min. The degradation temperature of the synthesized polyurethanes is around 290° C. for a 5% loss of mass, and around 424° C. for a 90% loss of mass. FIG. 4 is a curve representing the loss of mass, expressed as a percent, as a function of the temperature in degrees Celsius for a polyurethane with 30% crosslinking agent.

The DSC analyses were performed at heating and cooling rates of 5° C./min. During the analysis, a first heating was performed in order to eliminate the thermal history of the material.

As can be seen in the table above, temperatures of fusion/crystallization close to 20° C. were obtained.

The latent heat of the polyurethanes obtained ranges from 80 J/g to 110 J/g, depending on the formulation.

The combination of the PCM with a binder shall now be described.

The polyurethane obtained by the syntheses above was comminuted, then mixed with plaster, and the premix was then mixed with water. Advantageously, the polyurethane is obtained from a PEG with a molar mass of 1,500 g/mol, with a [NCO] ratio of 1 and a crosslinking of 20% with glycerol, this polyurethane having a Shore D hardness of 30 at 25° C., enabling it to be comminuted to a powder with a grain size of less than 100 microns. The temperature of fusion of this polyurethane is 27° C. and the associated latent heat of phase change is 106 J/g for P_{Ar}>1 bar.

The comminution was carried out using a knife mill, without heating the polyurethane.

The powder obtained is advantageously screened and advantageously has a grain size of less than 200 microns. A greater grain size has a negative impact on the compressive strength of the PCM-plaster mixtures.

The powdered PCM is mixed with plaster, the percent of PCM by mass varying between 20% and 35%.

During the mixing of the plaster/PCM composite material, the amount of water is calculated as a function of the water/dry matter ratio, in a manner similar to that for a conventional plaster. The setting of the composite is slightly slower than that of a conventional plaster, probably due to the hydrophilic nature of polyurethane.

After incorporation of the PCM into the plaster and drying of the composite, DSC analyses showed that the PCM is still capable of undergoing its phase changes and storing energy in the same proportions as in its initial state.

FIG. 1 illustrates the stability of the thermal properties of a plaster/PCM composite, the mass percent of thermosetting polyurethane in the plaster being 20. As can be seen in FIG. 1, no deterioration of the thermal properties of the composite could be detected during the implementation of heat cycles. The aging test was conducted in a climatic chamber, and the temperature cycles were performed between 5° C. and 50° C., FIG. 1 showing the differences between the temperature of the climatic chamber and the temperature of the plaster/PCM composite, measured in the center of the composite sample.

DSC measurements taken on the plaster/PCM composite and on the pure PCM show that the temperatures of fusion and crystallization of the composites and of the pure PCM are similar. The measured latent heat values are close to the theoretical latent heat values. FIG. 6 gives the DSC measurement results; the heating rate and the cooling rate being fixed at 5° C. per minute.

| | T fusion | T crystallization | Latent heat |
|---|---|---|---|
| | (° C.) | (° C.) | (J/g) |
| MCP (P_{Ar} < 1) | 27 +− 1 | 23 +− 1 | 90 +− 2 |
| Composite 10% | 28 +− 2 | 24 +− 1 | 8 +− 1 |
| Composite 20% | 28 +− 1 | 24 +− 1 | 21 +− 1 |
| Composite 30% | 28 +− 1 | 24 +− 1 | 27 +− 2 |

FIG. 5 shows the temperature progression as a function of time for a control polyurethane plate made of plaster and for a plate with the same dimensions made of plaster-polyurethane composite, these plates being placed in a climatic chamber (incubator).

As can be seen in FIG. 5, the rise in temperature in the composite plate is slower than in the control plate, and the maximum temperature attained is lower (around 2° C.). As the temperature in the climatic chamber decreases, the temperature in the plaster-polyurethane composite decreases more slowly than in the plaster control plate. The control and composite plates were equipped with the same kind of thermocouple positioned in the center, at mid-thickness, of the plate. The dimensions of the plates were 10 cm*10 cm*1.3 cm, and the volume of the thermal chamber was 108 liters, thus ensuring a uniform temperature of the environment surrounding the tested plates.

By virtue of its capacity to change the arrangement and organization (order) of its carbon chain in a plaster material, the PCM makes it possible to absorb/re-deliver thermal energy. In other words, the PCM is in a crystallized state, in which it is capable of absorbing thermal energy by transforming into an amorphous phase, in which the energy is stored. The transition from the amorphous state to the crystallized state is achieved by emitting the thermal energy previously stored.

This capacity is generalizable to any porous material (e.g., a porous material such as concrete, a refractory material having the ability to gain heat) that allows the PCM to change the arrangement and organization of its carbon chain.

The transition temperature is dictated to a large extent by the length of the chains, which depends on the PEGs employed, and the latent heat of the PCM. The longer the carbon chains of the PEG, the more heat gained by the PCM.

The amount of crosslinking agent in the chains also plays a role. The more crosslinking agent in the PCM, the less the chains are able to move and the less the PCM is able to gain heat.

In contrast to the currently implemented industrial techniques (specifically micro-encapsulation, macro-encapsulation, impregnation), the PCM is introduced directly into the plaster or the cement.

In an advantageous implementation, a premix is prepared prior to mixing. In other words, the PCM is incorporated in the solid state in order to form a PCM/plaster powder prior to mixing.

In another implementation, the PCM is mixed with the cement or plaster during the mixing of the plaster or of the cement.

Thermogravimetric analyses ranging from 20° C. to 700° C., aging tests (cycles of 50° C. to 5° C., 1° C./min, see FIG. 1) and mechanical resistance tests (uniaxial compression breaking load) were conducted on the products obtained. The addition of the PCM tends to reduce the compressive strength of the PCM-plaster composite in comparison to a conventional plaster.

Moreover, the PCM appears uniformly distributed in the composite.

The PCM obtained has numerous advantages.

The PCM undergoes its phase changes within a range of temperatures encountered in residential or office buildings, which is typically between 20° C. and 40° C., and more particularly between 19° C. and 28° C.

The PCMs obtained offer significant latent heats of phase change, for example ranging from 80 J/g to 120 J/g.

Since the PCM is advantageously synthesized without solvent, or even without solvent or catalyst, the use of the PCM has a negligible impact on the indoor air quality, and the health and safety risks associated with the synthesis or manipulation of the PCM are reduced.

The choice of reagents in the synthesis makes it possible to vary the solid-solid transition temperatures as well as the amount of energy stored, thus permitting a range of PCMs to be obtained.

The PCM can advantageously be mixed directly, without encapsulation, with another material, specifically for manufacturing coatings, plates or blocks of plaster or concrete.

The only reagent that is potentially hazardous to human health is the isocyanate, which is completely neutralized by the humidity of the ambient air after manufacturing.

The PCMs obtained are not completely soluble in water and can be mixed with a binder in the presence of water, and this property is linked to the addition of the crosslinking agent.

The PCMs obtained have a significant hardness (for example, a Shore D hardness ranging from 30 to 40, on the order of 40), permitting the controlled granulation thereof, in particular to form a powder with a grain size ranging from 100 microns to 300 microns, and this hardness property is linked to the addition of the crosslinking agent.

By using the PCM in the construction materials, it is possible to offer products that reduce the consumption of energy (specifically for air conditioning or heating) and increase thermal comfort in both winter and summer. The PCMs obtained have advantageous uses in terms of the thermal comfort of low thermal mass structures such as wooden structures or structures with thin walls and/or large glass surfaces.

The direct incorporation of the PCMs obtained into a matrix such as a hydraulic binder, for example, without need of encapsulation, substantially reduces the manufacturing costs.

The composite products comprising the PCM, in a dispersion, in an internal layer or in a surface coating, can be cut, drilled and sanded without affecting the properties of the product.

The composite elements comprising the PCMs can be used in plates, for example in suspended ceiling panels, or plates placed in the void above a suspended ceiling or stretched ceiling.

The addition of PCMs to a plaster matrix makes it possible to obtain an additional loss of mass, measured in thermogravimetric tests in which the temperature is raised up to 400° C. This loss of mass generates an additional heat consumption during a fire, thus retarding the deterioration of the PCM-plaster composite in comparison to conventional plaster.

The PCMs obtained are suitable for a large number of applications and in particular can be used for:
thermal control and protection of electronic components, the PCMs being applied, for example, directly to the component in a thin layer or placed in a heat sink. Such uses are of particular interest in installations such as data centers, for example, in which thermal regulation is complex and costly;
the packaging of medical products or samples;
internal combustion engines, for example for starting diesel engines;
insulating heat ducts or fluid lines;
protection of pavement from damage due to freezing;
protection of solar panels from heat;
in the textile industry, for thermal comfort.

1-26. (canceled)

27. A method for manufacturing a solid-solid organic phase-change material made of polyurethane, said method comprising:
a single step (i) of synthesis by mixing and reacting a liquid polyethylene glycol, a crosslinking agent, and a liquid polyisocyanate, combined by mechanical agitation at a first controlled temperature, in an enclosure in order to obtain the liquid polyurethane,
a step (ii) of curing the liquid polyurethane at a second controlled temperature in order to solidify the polyurethane,
the synthesis step (i) being carried out in the absence of a solvent.

28. The method according to claim 27, characterized in that the polyisocyanate is linear.

29. The method according to claim 27, characterized in that the crosslinking agent has functional groups intended to attach only to the NCO bonds of the polyisocyanate.

30. The method according to claim 29, characterized in that the crosslinking agent only has OH functional groups.

31. The method according to claim 30, characterized in that between 0.2n to 0.4n crosslinking agent OH functional groups are added for n OH functional groups of the polyethylene glycol.

32. The method according to claim 27, characterized in that the crosslinking agent is a polyol.

33. The method according to claim 27, characterized in that the crosslinking agent is glycerol.

34. The method according to claim 27, characterized in that the synthesis step (i) is carried out without a catalyst.

35. The method according to claim 27, characterized in that the polyisocyanate is HMDI or 1,8-diisocyanatooctane.

36. The method according to claim 27, characterized in that the polyisocyanate is HMDI and the crosslinking agent is glycerol, and the synthesis is:

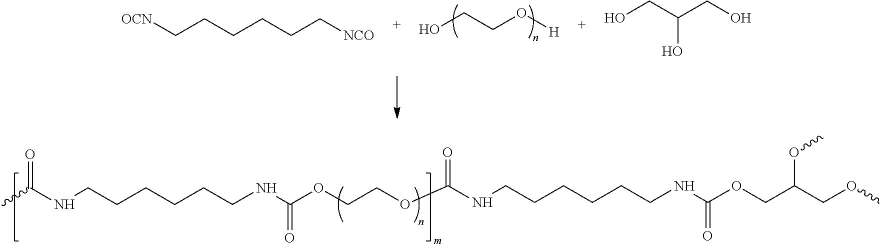

37. The method according to claim 27, characterized in that the ₜₒₜₐₗNCO/OH ratio ranges from 0.8 to 1.1.

38. The method according to claim 27, characterized in that the second controlled temperature ranges from 100 to 150° C. and that the curing step (ii) lasts several hours.

39. The method according to claim 27, characterized in that the synthesis step (i) is carried out under inert gas pressure.

40. The method according to claim 39, characterized in that the inert gas pressure is greater than 1 bar.

41. The method according to claim 39, characterized in that the inert gas is argon or nitrogen.

42. An organic solid phase change material, solid-solid type, with no solvent residues, made of polyurethane formed from a polyethylene glycol, a crosslinking agent and a polyisocyanate, the polyisocyanate being chosen from the following list: HMDI, 1.8 diisocyanatooctane, linear diisocyanate or mixture of linear diisocyantes.

43. The material according to claim 42, characterized in that the material has a transition latent heat between 80 and 120 J/g for PEGs of 1000 to 2000 g/mol.

44. The material according to claim 42, characterized in that the material has a Shore D hardness ranging between 30 and 40.

45. The material according to claim 42, characterized in that the material does not include catalyst residues.

46. The method according to claim 42, characterized in that the crosslinking agent is a polyol.

47. The material according to claim 42, wherein the polyisocyanate is HMDI, the crosslinking agent is glycerol and the material obtained has the following form:

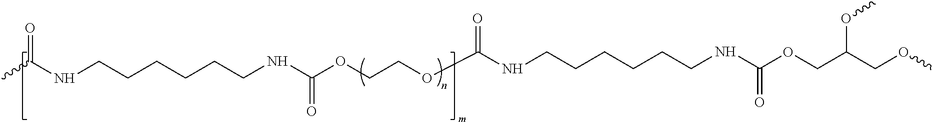

48. The material according to claim 42, characterized in that the rate of crosslinking of the material is between 10% and 50%, and more particularly between 20% and 40%.

49. The method according to claim 42, characterized in that the ₜₒₜₐₗNCO/OH ratio ranges from 0.8 to 1.1 in the constituants used to form the material.

50. The material according to claim 42, characterized in that the material has polymer chains bridged by urethane functional groups, and that for n polyethylene glycol in the material, the material has 0.2n to 0.4n urethane functional groups originating from the crosslinking agent.

51. The method according to claim 42, characterized in that the crosslinking agent is an HDMI.

52. The material according to claim 42, characterized in that the material is in the form of a solid powder.

53. The material according to claim 52, characterized in that the material is in the form of a powder, the grain size of which is between 10 and 500 microns, and more particularly between 100 and 300 microns.

54. A method for incorporating a solid-solid organic phase-change material according to claim 42 into a hydraulic binder, method in which:
a solid powder with a grain size ranging from 10 to 500 microns, and more particularly from 100 to 300 microns, is made from the solid-solid organic phase-change material;
the organic phase-change material solid powder is mixed with the solid powder of the hydraulic binder to obtain a composite material;
the composite mixture is mixed by adding an amount of water.

55. The method according to claim 54, in which the hydraulic binder is plaster.

56. The method according to claim 54, in which the hydraulic binder is cement.

57. The method according to claim 54, in which the composite material comprises from 20% to 35% of the solid-solid organic phase-change material.

58. The method according to claim 54, in which the molar masses of the polyethylene glycol range from 200 g/mol to 2,000,000 g/mol, and more particularly from 1,000 g/mol to 10,000 g/mol, and still more particularly from 1,000 g/mol to 2,000 g/mol.
